(19) United States
(12) Patent Application Publication
(10) Pub. No.: US 2014/0379556 A1
(43) Pub. Date: Dec. 25, 2014

(54) Credit Payment Method for Foreign Tourists

(71) Applicant: Han Kyum CHOI, Pusan (KR)

(72) Inventor: Han Kyum CHOI, Pusan (KR)

(21) Appl. No.: 13/922,092

(22) Filed: Jun. 19, 2013

(51) Int. Cl. G06Q 20/24

(52) U.S. Cl. CPC G06Q 20/24
USPC 705/39

(57) ABSTRACT

This invention provides a credit card method for foreigners includes steps: foreign tourist accesses the information management server with information on the goods provided by domestic tourism goods provider(s); foreign tourist selects desired goods on the server; a domestic financial institution creates an account; the foreign tourist makes a temporary payment to the account for the goods; the domestic financial institution credits the account with the sum of the temporary payment amount and the weighted value points and issues a means of payment that is linked to the account; foreign tourist is provided with this means of payment after entering the country; foreign tourist makes an actual payment for the goods provided by the good provider using this means of payment; and the domestic financial institution withdrawing money, in the actual amount of payment, from the account to be wired to the goods provider.

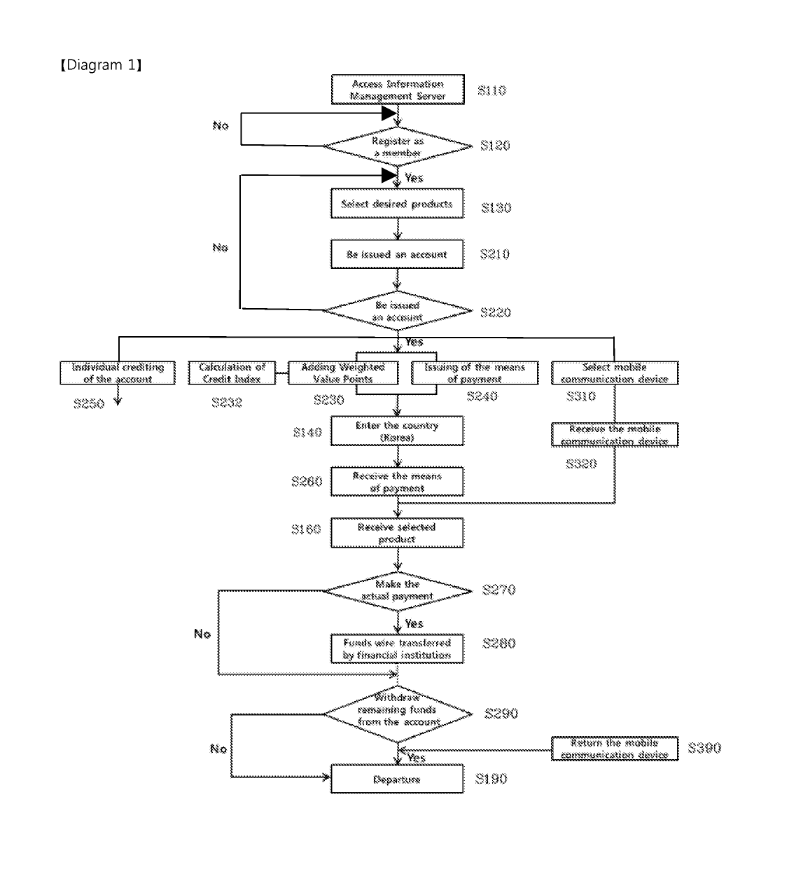

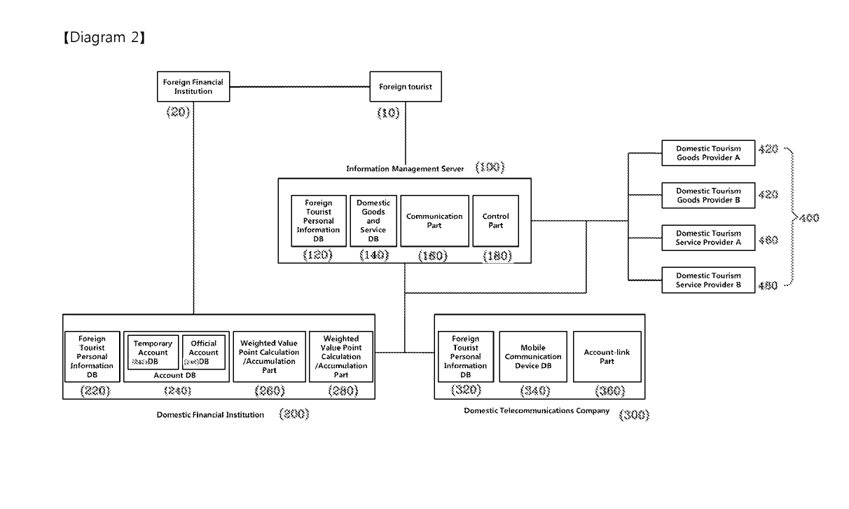

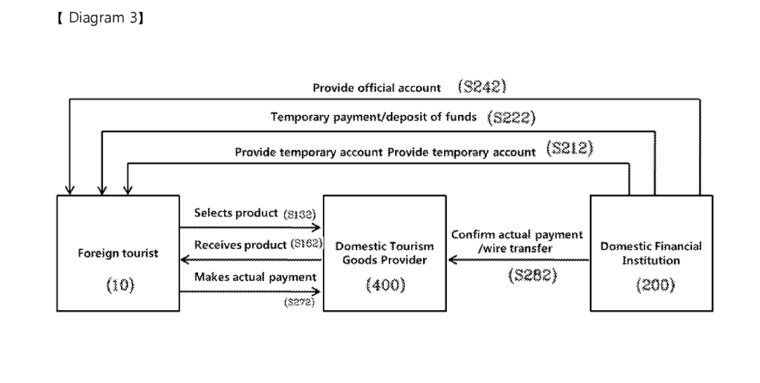

### TECHNICAL ASPECT

This invention is regarding a credit payment method for foreign tourists that is linked to at least one domestic financial institution and involves the following steps: foreign tourist accesses the information management server with information on the goods provided by domestic tourism goods provider(s); foreign tourist selects desired goods on the information management server; a domestic financial institution creates an account to be assigned to the foreign tourist; the foreign tourist makes a temporary payment to the account for the goods selected; the domestic financial institution credits the account with the sum of the temporary payment amount and the weighted value points and issues a means of payment that is linked to the account when the funds for the temporary payment are deposited into the account; foreign tourist is provided with this means of payment after entering the country; foreign tourist makes an actual payment for the goods provided by the domestic tourism good provider using this means of payment; and the domestic financial institution withdrawing money, in the actual amount of payment, from the account to be wired to the domestic tourism goods provider.

### TECHNICAL BACKGROUND OF THE INVENTION

The tourism industry, often referred to as a ‘factory without chimneys,’ is an important contributor to the national economy of South Korea, which lacks natural resources. In particular, the tourism industry is regarded as a strategic industry that will stimulate economic and social development worldwide. The tourism powerhouses, namely France, Italy, Switzerland and the U.S., have been making a significant amount of investment and developing numerous policies to facilitate the development of their tourism industries since long ago.

The development of the tourism industry has become the common policy objective of nearly all countries in the world due to the high rate of foreign exchange earnings, its effect in job creation and employment, and eco-friendly characteristics. The tourism industry also serves an important role in promoting the nation's excellent culture to foreigners and gaining a more positive image, thereby enhancing the national brand power.

Korea has implemented a wide range of policies to cultivate the tourism industry to emerge as the tourism center of Asia in the 21^{st} century. Of particular note, there has been an increasing global interest in Korea as a result of the Korean wave (Hallyu) caused by Korean dramas and K-pop artists and groups. However, despite having these quality tourism resources, the tourism surplus decreased sharply and the deficit has actually been increasing in the recent years due to the absence of policies to make an efficient use of these resources.

The reason for the gradual increase in tourism deficit is that the number of Korean citizens traveling abroad has increased more substantially in comparison to the increasing number of foreigners visiting Korea. In addition, the size of the total consumption by foreign tourists has not expanded significantly. The latter case, in particular, is caused by the fact that it is difficult for potential foreign tourists to obtain information necessary to locate the areas they wish to visit and calculate the necessary expenditures when they are planning their trips.

Moreover, the payment methods that foreigners can use for goods and services are limited to cash and personal credit cards. This means that they cannot gain any of the benefits that are provided to Korean citizens during transactions except tax exemption, and thus, foreigners are reluctant to make purchases unless it is absolutely necessary.

To resolve these issues, Republic of Korea Open Patent No. 2003-0094525 proposes a system and method for providing tourism information and payment services using a memory card, while Republic of Korea Open Patent No. 2004-0019659 proposes a payment method using tourism membership card and e-money. These two methods are characterized by the use of a memory card of a card containing an IC chip to pay for goods and services using the money already charged into the account or electronic currency.

However, these methods require foreign tourists to use a memory card or IC chip that has already been charged with the necessary funds when making transactions and the amount that they can potentially spend is limited to the funds have already been charged into the memory card or IC chip. This means that in case of insufficient funds, they must either replace the memory card or recharge it with the necessary funds.

Other drawbacks include the fact that these methods cannot be used prior to entering the country and can be used only after their arrival in Korea. Moreover, these methods are no different from using actual currency in that they do not provide any of the benefits given to Korean citizens when they use credit cards for transactions, and provide no incentives for foreigners to increase their spending. In addition, although credit transactions have become common in most countries around the world, foreign tourists in Korea cannot enjoy the same benefits provided to Korean citizens by domestic financial institutions.

### PRECEDENT TECHNICAL DOCUMENTS

### Patent Documents

Republic of Korean Open Patent No. 2003-0094525, Republic of Korean Open Patent No. 2004-0019659, Republic of Korean Open Patent No. 2009-0114514, Republic of Korean Open Patent No. 2010-0077295, Republic of Korean Registered Patent No. 1043555

### SUMMARY OF THE INVENTION

### Issues to Be Resolved

This invention was proposed to solve the aforementioned issues. It is an account-linked credit payment method that can be used by foreigners when making transactions while traveling in Korea.

One of the objectives of this invention is to provide a credit payment method that will provide foreigners making transactions while traveling in Korea the same benefits that are provided to Korean nationals.

Another objective of this invention is to provide a credit payment method that will provide foreigners making transactions while traveling in Korea additional benefits that correspond to the amount of purchases.

Another objective of this invention is to provide a credit payment method that will facilitate the tax reimbursement process for tax-free goods when foreigners make transactions while traveling in Korea without having to follow additional procedures.

Another objective of this invention is to provide a credit payment method that will provide the information on the goods to be purchased and the account information related to the transaction using a mobile communication device for foreigners traveling in Korea.

Another objective of this invention is to provide a credit payment method that will facilitate transactions using a mobile communication device linked to the account issued by a domestic financial institution for foreigners traveling in Korea.

### Means to Resolve the Issues

In order to achieve the above objectives, this invention is linked to at least one domestic financial institution and involves the following steps: foreign tourist accesses the information management server with information on the goods provided by domestic tourism goods provider(s); foreign tourist selects desired goods on the information management server; a domestic financial institution creates an account to be assigned to the foreign tourist; the foreign tourist makes a temporary payment to the account for the goods selected; the domestic financial institution credits the account with the sum of the temporary payment amount and the weighted value points and issues a means of payment that is linked to the account when the funds for the temporary payment are deposited into the account; foreign tourist is provided with this means of payment after entering the country; foreign tourist makes an actual payment for the goods provided by the domestic tourism good provider using this means of payment; and the domestic financial institution withdrawing money, in the actual amount of payment, from the account to be wired to the domestic tourism goods provider.

The above process, in which foreign tourists select the goods to be purchased, may be preceded by a membership registration process in which foreign tourists must register in the information management server.

The above domestic financial institution may create a temporary account to be provided to a foreign tourist, and issue an official account only after the funds for the temporarily purchased goods are deposited into the temporary account by the foreign tourist.

The weighted value points may be determined by the above domestic financial institution based on the time period between the day when the amount for temporary payment was deposited into the account and the day when the actual payment took place using the designated means of payment.

The above weighted value points may be determined, considering tax reimbursement as well as the interest rate and foreign currency rate between the day when the amount for temporary payment was deposited into the account and the day when the foreign tourist made the actual payment using the designated means of payment.

The above domestic financial institution may calculate the credit index of the foreign tourist when granting weighted value points.

The above credit index can be newly determined and accumulated each time the foreign tourist makes an actual payment using the designated means of payment.

The above credit index can be managed separately from the funds credited to the account.

The above information management server is linked to at least one domestic telecommunications company. When the foreign tourist requests a mobile communication device on the information management server, the above domestic telecommunications company may temporarily activate a mobile communication device that is linked to the account created by the domestic financial institution concerned.

Also, the above information management server is linked to at least one domestic telecommunications company. When the foreign tourist requests a mobile communication device on the information management server, the above domestic telecommunications company may temporarily activate a mobile communication device that is linked to the account created by the domestic financial institution concerned, and the said mobile communication device may be embedded with the means to use the payment method issued by the above domestic financial institution.

The above mobile communication device can provide information on the goods selected by the foreign tourist and the account information in real-time.

After the above domestic financial institution credits the temporary payment amount plus the weighted value points to the account, the foreign tourist can use the funds equaling to the total sum credited to the account, using payment method.

### Effect of the Invention

This invention proposes a method with which foreigners can purchase goods prior to entering Korea by depositing the amount for the payment to the account opened under their name in order to allow foreign tourists to calculate the funds necessary to travel in Korea in advance.

It allows foreign tourists making transactions while traveling in Korea to withdraw some of the funds deposited into their accounts, but it also allows foreign tourists to use the payment method issued by the domestic financial institution that is linked to their accounts to purchase goods and services in Korea without using cash or credit card.

It also allows foreign tourists making transactions while traveling in Korea to receive the same benefits as Korean citizens by providing the financial benefits arising from the difference between the time when the charged amount for the domestic tourism goods is deposited into the account issued by the domestic financial institution and the time when the goods are received and paid for by the foreign tourist.

The weighted value that is added when the foreign tourist purchases goods has been designed to take into account the aspect of tax exemption in order to ensure that foreign tourists can receive tax benefits without having to follow the tedious tax reimbursement procedures prior to their departure. The credit level is assessed every time the foreign tourist makes a purchase to be provided as cumulative mileage points. Thus, foreign tourists can receive benefits corresponding to the amount that has been transacted while traveling in Korea. Foreign tourists can obtain information on the purchased goods and their accounts using the mobile communication devices provided, at any time in their native languages. This is expected to allow foreign tourists to travel around Korea with convenience.

The mobile communication devices that are provided to the foreign tourists temporarily contain the means of payment. This means that foreign tourists do not need separate means of payment such as cash or credit card and solely use the mobile communication devices to make easy transactions.

### BRIEF DESCRIPTIONS OF THE DIAGRAMS

Diagram 1 is a schematic flow chart of the credit payment system for foreign tourists, the product of this invention.

Diagram 2 is a schematic system diagram of the credit payment system for foreign tourists, the product of this invention.

Diagram 3 is a schematic flow chart of the process of creating an account for the credit payment system for foreign tourists, the product of this invention.

### SPECIFICS FOR IMPLEMENTATION

The details on the desirable implementation of this invention are mentioned below in reference to the attached Diagrams. However, detailed descriptions of matters that have no direction relation to the technical characteristics of the invention or matters that are self-evident to those with common knowledge in the technical field are omitted.

Diagram 1 is a schematic flow chart of the credit payment system for foreign tourists, the product of this invention. Diagram 2 is a schematic system diagram of the credit payment system for foreign tourists, the product of this invention.

First, foreign tourists (10) must log on (5110) to the information management server (100). The information management server (100), which provides information on various tourism goods and services to foreign tourists, is comprised of a personal information DB (120) of foreign tourists, domestic tourism goods and services DB (140), communication part (160) and control part (18).

The foreign tourist personal information DB (12) maintains information on the goods and services (hereinafter referred as “product”) and travel itinerary selected by the foreign tourists in addition to maintaining the personal information of foreign tourists traveling in Korea. The above domestic tourism goods and services DB (140) stores information on various tourism product that can be enjoyed by foreigners after entering Korea and each of the tourism product is linked to the servers of the domestic tourism goods and service providers (400). Tourism products may be a single product or a package of multiple single products. The communication part (160) communicates with servers other than the information management server, while the control part (180) is responsible for the overall control of the information management server.

The information management server (100) is linked to at least one domestic financial institution (200). The domestic financial institution (200) should be an institution that can create and manage an account, and a conventional domestic bank would be applicable. The domestic financial institution (200) should have a foreign tourist personal information DB (210), account DB (240), weighted value point calculation/accumulation section (260), credit index point calculation/accumulation section (180).

The foreign tourist personal information DB (210) maintains the personal information of foreign tourists who created accounts with this system, while the account DB (240) creates and manages the accounts issued to the foreign tourists and is comprised of a temporary account DB (242) and an official account DB (246), the details of which will be described later. The weighted value point calculation/accumulation section (260) and the credit index point calculation/accumulation section (180) calculate and manage the weighted value and credit index, respectively, based on the amount transacted by the foreign tourists, and their specific functions will be described later.

A foreign tourist (10) can log on to the information management server (100) linked with various institutions and businesses as described above to search for information on various products provided by the information management server (100) and select a product that suits his/her taste or satisfies his/her purpose of travel (S130). Products selected by the foreign tourist may be a flight ticket, hotel room, medical service or tour program or a combination of any of these.

Before the foreign tourist (1) can select a product on the information management server (100), he/she may be required to register as a member. For membership registration, the foreign tourist's (1) personal information such as nationality, name, emergency contact and passport number may be required and such information will be registered and maintained in the foreign tourist personal information DB (120).

When a foreign tourist (10) selects a product, the domestic financial institution (200) will create an account to be assigned to the foreign tourist (10), who will then make a temporary payment for the selected product to the account (S220). In common transactions, payment is made directly for the product, but in this case, payment is made by accumulating the funds in the temporary account created by the domestic financial institution. The account created by the domestic financial institution (200) may be an account at a domestic branch or an overseas branch of the domestic financial institution, and in case it is an overseas branch, it may be located in the resident country of the foreign tourist. For the temporary payment, the foreign tourist (10) may directly wire the money to the account or use a credit card. Thus, the foreign financial institution (20) shown in Diagram 2 may be a foreign bank or a foreign credit card company.

When the amount is deposited by the foreign tourist (10) to the account created by the domestic financial institution (200) for the temporary payment, the domestic financial institution (200) will add the temporary payment amount (product price) and the weighted value to be credited to the account (S230) and a means of payment linked to the credit will be issued (S240) to the foreign tourist (10).

The weighted value is added with the expectation that the foreign tourist will actually purchase the product he/she selected on the information management server and may change depending on the duration between the day when the temporary payment was made to the issued account and the day when the actual payment was made by the foreign tourist (10) using the issued means of payment. The weighted value may be calculated, taking into account the interest rate, foreign currency rate and tax reimbursement. Of these factors taken into consideration, for tax reimbursement, details regarding whether the product is subject to tax exemption, the degree of tax deduction and additional tax cuts may be considered. This is the reason the account of the foreign tourist (10) will be credited with more funds than the amount corresponding to the temporary payment amount.

This is a way of returning the benefits arising from the gap between the day the product was selected and temporarily paid for and the day when the product was actually provided to the foreign tourist after entering the country. In other words, foreign tourists can receive the same benefits offered by the domestic financial institution to Korean citizens for the funds credited to the account. If the foreign tourist selects and makes a temporary payment for multiple products, then he/she will receive the benefits in weighted value points for each of the product based on when the temporary and actual payments are made. It's the weighted value point calculation/accumulation section (260) of the domestic financial institution (200) that is responsible for applying, calculating, crediting and managing the weighted value points. This invention does not rule out the case in which the domestic financial institution (200) calculates a credit index (S232) for the foreign tourist (10) when granting weighted value points. The credit index is similar to the concept of credit rating assessment that is performed on Korean citizens by domestic financial institutions. In other words, a credit index is an assessment tool for ‘customer reliability,’ and examines how reliable a foreign tourist (10) is in actually receiving and making a payment for the temporarily paid product.

Thus, it is desirable to have a credit index that can be newly created and accumulated every time the foreign tourist makes an actual payment using the a means of payment, and be managed separately from the amount credited to the account. However, if the foreign tourist has never engaged in any financial transactions with the domestic financial institution concerned, then his/her credit index will be determined on the day he/she receives and makes an actual payment for the product that was temporarily paid for.

To encourage product purchases and the actual payment for the temporarily purchased goods, the domestic financial institution may manage the credit index by assigning a set default value when the foreign tourist makes an initial purchase and add more to the default value when the actual payment is made for the product. Also, the credit index may be managed in a similar fashion as bonus or mileage points, just as how Korean citizens are given mileage or bonus points when making purchases using credit cards. It is the credit index point calculation/accumulation section (180) of the domestic financial institution (200) that is responsible for applying, calculating, crediting and managing the credit index.

A common card can be used as the above means of payment, which is linked to the account credited with the sum of the temporary payment amount and the weighted value points. Also, the means of payment will also be linked with the weighted value points that are managed separately from the sum of the temporary payment amount and the weighted value points credited to the account.

After the sum of the temporary payment amount and the weighted value points is credited to the account and the means of payment has been issued, the foreign tourist will accept the means of payment (S260) after entering Korea (S140). The domestic financial institution may send the means of payment to the branch or office located at the airport or seaport, to which the foreign tourist is expected to arrive, for delivery. However, if the domestic financial institution (200) has an overseas branch in the country where the foreign tourist (10) resides, he/she may receive the means of payment at the overseas branch prior to his/her departure.

For this invention, it is recommended that the domestic financial institution (200) create a temporary account to be assigned to a foreign tourist and then create an official account once the temporary payment is made to the temporary account by the foreign tourist. Here, this process will be explained in detail in reference to Diagram 3.

First, when a foreign tourist (10) selects a product (132), the domestic financial institution (200) will create a temporary account to be assigned to the foreign tourist (10). Then, the foreign tourist (10) will make a temporary purchase using the temporary account and deposit the corresponding funds (S222). Once it has been confirmed that the foreign tourist (10) made the appropriate deposit into the account, the domestic financial institution (200) will issue a temporary account and an official account (S242) to the foreign tourist (10), and the means of payment to be issued will be linked with the official account.

This is advantageous because if the foreign tourist makes a credit card payment, instead of paying for the product directly from their bank account, he/she may cancel the transaction in case he/she has a change of mind. Thus, if the payment for the product is not made directly from the account, it is recommended that a temporary account be created and issued before providing an official account. For this purpose, the domestic financial institution's (200) account DB (240) may be comprised of a temporary account DB (242) and an official account DB (246). The temporary account DB (242) and the official account DB (246) are interlinked.

Foreign tourists may select from a wide range of domestic tourism products available on the information management server (100) before and after arriving in Korea and receiving the means of payment. In other words, a foreign tourist (100) can purchase additional products, following the aforementioned procedures, if there are products they wish to purchase during their travel period. However, since the foreign tourist (100) has already been issued an account, the amount for the transactions will be credited to the existing account. The calculation for the weighted value points will be performed separately for each of the products purchased, and the method of credit index calculation and accumulation is similar to that of weighted value points.

After receiving the means of payment, the foreign tourist (10) will visit the domestic tourism goods and services provider in question to receive the product concerned (S160) and make an actual payment using the means of payment provided (S270). The amount corresponding to the actual payment will be wire transferred to the domestic tourism goods and services provider (400) concerned by the domestic financial institution (200). In other words, as shown in Diagram 3, if the domestic tourism goods and services provider (400) provides the product concerned (S162) to the foreign tourist (10), the foreign tourist (10) will pay for the product using the issued means of payment (S272). As soon as this transaction is confirmed by the domestic financial institution (200), the amount corresponding to the payment will be withdrawn from the account (S282).

In other words, using this invention, foreign tourists do not have to make immediate payment to the goods and service provider when purchasing a product prior to their arrival in Korea (or when purchasing additional products after their arrival) and instead, pay for the product after actually receiving it when they are in Korea. This allows foreign tourists to receive financial benefits resulting from the gap between time of purchase and time of actual payment as well as mileage points.

Meanwhile, this invention does not rule out the case in which the foreign tourists (10) make a deposit of a given sum to the account (S250) issued by the domestic financial institution (200). The deposited sum is not related to the amount deposited for the temporary purchase of a product. Funds can be deposited as soon as an official account is issued by the domestic financial institution. Funds that are deposited in this manner can be withdrawn at any time since they are not reserved for payment for specific goods or services.

Thus, such funds must be managed separately from the funds that are reserved for the actual payment of the temporarily purchased product. In other words, it is recommended that the weight value for this type of funds be applied differently from the weighted value applied to the funds that will be used to pay for the temporarily purchased products, and same is true for the calculation of credit index. However, it is recommended that such funds be withdrawn using the same means of payment as the one used to pay for temporarily purchased products.

Also, in this invention, the information management server (100) is linked with at least one domestic telecommunications company (300), through which foreign tourists (10) can receive various convenient services. Because the domestic telecommunications company (300) rents out mobile communication devices to the foreign tourists upon their request, its server should be comprised of at least a foreign tourist personal information DB (320), mobile communication device DB (340), and account-link part (360).

The above foreign tourist personal information DB (320) manages the personal information of foreign tourists that requested mobile communication devices, while the mobile communication device DB (340) contains information on the mobile communication devices that are rented out. The account-link part (360) is linked to the accounts issued to the foreign tourists by the domestic financial institution (200) to claim and settle the fee for the use of the mobile communication device.

Foreign tourists (10) can designate a specific telecommunications company (300) in Korea once their official accounts are issued by the domestic financial institution (200) and request a mobile communication device (S310). In this case, the domestic telecommunications company (300) will activate a mobile communication device that can be used temporarily by the foreign tourist during his/her stay in Korea and send it to its branch or office at the airport, etc., in a timely fashion to be given to the tourist upon his/her arrival in Korea (S320).

It is recommended that the foreign tourists be able to use the mobile communication device to access and obtain information on the products they temporarily purchased and their account information at any time they want. In addition, the mobile communication device may provide information on their schedule/itinerary. Also, even if it is not requested by the foreign tourists, the domestic telecommunications company may make sure the mobile communication devices provide information in their native languages.

Meanwhile, the mobile communication device may be embedded with the means of payment if such is requested by the foreign tourist. The means of payment may be a chip, containing a wide range of information on the means of payment issued by the domestic financial institution (200). In this case, the account-link part (360) of the domestic telecommunication company's (300) server should communicate with the domestic institution's (200) server at all times to be in link with the foreign tourist's account.

As such, if the means of payment issued by the domestic financial institution (200) is a chip that is embedded in a mobile communication device, all the transactions made by the foreign tourist (10) while his/her travel in Korea will be made using the mobile communication device through communication with the domestic financial institution (200). Its specific route is similar to the flow shown in Diagram 3. Also, in this case, the funds deposited independently from the funds deposited for the temporary payment as per 5250 can be withdrawn at any time using the means of payment embedded in the mobile communication device.

At the end of the trip, foreign tourists (10) can withdraw the remaining funds in the account (S290) before their departure (S190). In contrast, they can also withdraw some of the funds or choose to not withdraw any of the funds. In the latter case, the account will remain active, and the foreign tourist concerned can use this account to purchase the domestic tourism goods and services or use it when re-visiting Korea at a later time.

It is obvious that the means of payment should be structured and designed in such a way that it fulfills its aforementioned purpose and be used for a particular period of time with requiring a replacement. However, if the means of payment is embedded in the mobile communication device, the foreign tourists won't be able to use it again at a later time since they will have to return the device prior to their departure (S390). Thus, in this case, it is recommended that they withdraw all the remaining funds from the account. However, if they choose not to withdraw the funds, they will have to request the domestic financial institution to issue a new means of payment that is linked to their existing accounts when they re-enter Korea at a later time.

Desirable examples of implementation of the invention were explained above. However, these are simply examples and this invention is not limited to these examples and can be altered in various ways for implementation. It is self-evident that additional technical characteristics may be added to this basic technical idea.

### SYMBOLS

100: Information management server

200: Domestic financial institution

300: Domestic telecommunications company

400: Domestic tourism goods and service provider

What is claimed is:

1. This is a credit payment method for foreign tourists that is linked to at least one domestic financial institution, and includes the steps in which foreign tourists can access the information management server offering at least one domestic tourism goods and services;
foreign tourists can select desired goods on the information management server;
a domestic financial institution creates an account to be assigned to the foreign tourist;
the foreign tourist makes a temporary payment to the account for the goods selected;
the domestic financial institution credits the account with the sum of the temporary payment amount and the weighted value points and issues a means of payment that is linked to the account when the funds for the temporary payment are deposited into the account;
foreign tourist is provided with this means of payment after entering the country (Korea);
foreign tourist makes an actual payment for the goods provided by the domestic tourism good provider using this means of payment; and
the domestic financial institution withdrawing money, in the actual amount of payment, from the account to be wired to the domestic tourism goods provider.

2. With respect to claim 1, this credit payment method for foreign tourists is characterized by a membership registration process in which foreign tourists must register their information in the information management server before they can select the goods they wish to purchase.

3. With respect to claim 1, this credit payment method for foreign tourists is characterized by the fact that the domestic financial institution concerned may create a temporary account to be provided to a foreign tourist, and issue an official account only after the funds for the temporarily purchased goods are deposited into the temporary account by the foreign tourist.

4. With respect to claim 1, this credit payment method for foreign tourists is characterized by the fact the weighted value points may be determined by the domestic financial institution based on the time period between the day when the amount for temporary payment was deposited into the account and the day when the actual payment took place using the designated means of payment.

5. With respect to claim 4, this credit payment method for foreign tourists is characterized by the fact the above weighted value points may be determined, considering tax reimbursement as well as the interest rate and foreign currency rate between the day when the amount for temporary payment was deposited into the account and the day when the foreign tourist made the actual payment using the designated means of payment.

6. With respect to claim 1, this credit payment method for foreign tourists is characterized by the fact the domestic financial institution may calculate the credit index of the foreign tourist when granting weighted value points.

7. With respect to claim 6, this credit payment method for foreign tourists is characterized by the fact the credit index can be newly determined and accumulated each time the foreign tourist makes an actual payment using the designated means of payment.

8. With respect to claim 7, this credit payment method for foreign tourists is characterized by the fact the calculated credit index can be managed separately from the funds credited to the account.

9. With respect to claim 1, this credit payment method for foreign tourists is characterized by the fact the information management server is linked to at least one domestic telecommunications company. When the foreign tourist requests a mobile communication device on the information management server, the above domestic telecommunications company may temporarily activate a mobile communication device that is linked to the account created by the domestic financial institution concerned.

10. With respect to claim 1, this credit payment method for foreign tourists is characterized by the fact the aforementioned information management server is linked to at least one domestic telecommunications company. When the foreign tourist requests a mobile communication device on the information management server, the aforementioned domestic telecommunications company may temporarily activate a mobile communication device that is linked to the account created by the domestic financial institution concerned, and the said mobile communication device may be embedded with the means to use the payment method issued by the aforementioned domestic financial institution.

11. With respect to claim 10 or claim 11, this credit payment method for foreign tourists is characterized by the fact the aforementioned mobile communication device can provide information on the goods selected by the foreign tourist and the account information in real-time.

12. With respect to claim 1, this credit payment method for foreign tourists is characterized by the fact the above domestic financial institution credits the temporary payment amount plus the weighted value points to the account, the foreign tourist can use the funds equaling to the total sum credited to the account, using payment method.
